(19) United States
(12) Patent Application Publication
(10) Pub. No.: US 2016/0202539 A1
(43) Pub. Date: Jul. 14, 2016

(54) LIQUID CRYSTAL DISPLAY AND MANUFACTURING METHOD THEREOF

(71) Applicant: Samsung Display Co., Ltd., Yongin-City (KR)

(72) Inventor: Jin-Lak KIM, Osan-si, Gyeonggi-do (KR)

(21) Appl. No.: 14/823,833

(22) Filed: Aug. 11, 2015

(30) Foreign Application Priority Data
Jan. 9, 2015 (KR) 10-2015-0003675

(51) Int. Cl. G02F 1/1333; G02F 1/1341; G02F 1/1362; G02F 1/1368

(52) U.S. Cl. CPC G02F 1/133345; G02F 1/1368; G02F 1/133377; G02F 1/1341; G02F 1/136286; G02F 2001/136295

(57) ABSTRACT

A liquid crystal display is provided. The liquid crystal display according to an exemplary embodiment includes: a substrate; a thin film transistor disposed on the substrate; a pixel electrode disposed on the thin film transistor; a roof layer facing the pixel electrode; an upper insulating layer disposed on the roof layer; and a liquid crystal layer disposed between the pixel electrode and the roof layer and comprising a plurality of microcavities adjacent to each other including liquid crystal molecules, wherein the upper insulating layer includes titanium oxide.

### CROSS-REFERENCE TO RELATED APPLICATION

This application claims priority to and the benefit of Korean Patent Application No. 10-2015-0003675 filed in the Korean Intellectual Property Office on Jan. 9, 2015, the entire contents of which are incorporated herein by reference.

### BACKGROUND

(a) Field

The present application relates to a liquid crystal display and a manufacturing method thereof.

(b) Description of the Related Art

A liquid crystal display, which is one of the most widely used flat panel displays, includes two sheets of display panels on which electric field generating electrodes such as pixel electrodes, common electrodes, and the like are formed and a liquid crystal layer interposed therebetween.

The liquid crystal display displays an image by applying a voltage to the electric field generating electrodes to generate an electric field on the liquid crystal layer and consequently, determining an orientation of liquid crystal molecules of the liquid crystal layer and controlling polarization of incident light.

As one among the liquid crystal displays, a technology of implementing a display by forming a plurality of microcavities in a pixel and filling a liquid crystal material, e.g., including liquid crystal molecules, into the plurality of microcavities has been developed. Although the liquid crystal display according to the related art uses two sheets of substrates, the above-mentioned technology may reduce a weight, a thickness, and the like of the liquid crystal display by forming components on one substrate.

According to the method of manufacturing the display device described above, a liquid crystal material may be injected into the microcavity through a narrow open region. After the liquid crystal material is injected into the microcavity, the liquid crystal material fills the microcavity and remains in regions other than the microcavity. Therefore, due to the remaining liquid crystal material, a light leakage defect, or the like may occur.

The above information disclosed in this Background section is only for enhancement of understanding of the background and therefore it may contain information that does not form the prior art that is already known in this country to a person of ordinary skill in the art.

### SUMMARY

Embodiments have been made in an effort to provide a liquid crystal display and a manufacturing method thereof having features capable of reducing the remaining liquid crystal material.

An exemplary embodiment provides a liquid crystal display including: a substrate; a thin film transistor disposed on the substrate; a pixel electrode disposed on the thin film transistor; a roof layer facing the pixel electrode; an upper insulating layer disposed on the roof layer; and a liquid crystal layer disposed between the pixel electrode and the roof layer and comprising a plurality of microcavities including liquid crystal molecules, wherein the upper insulating layer includes titanium oxide.

A surface of the upper insulating layer may include a surface reformed by an ultraviolet (UV) surface treatment.

The surface of the upper insulating layer which is reformed by the ultraviolet (UV) surface treatment may be super hydrophilic.

The liquid crystal display may further include a lower insulating layer disposed below the roof layer and facing the pixel electrode based on the microcavity.

The lower insulating layer may include silicon nitride or silicon oxide.

The liquid crystal display may further include a common electrode disposed below the lower insulating layer and facing the pixel electrode based on the microcavity.

The roof layer may cover an open part formed between the plurality of microcavities adjacent to each other.

The liquid crystal display may further include a capping layer disposed on the upper insulating layer.

The plurality of microcavities may have a liquid crystal injecting portion formed therebetween and the capping layer may cover the liquid crystal injecting portion.

Another embodiment provides a manufacturing method of a liquid crystal display including: forming a thin film transistor on a substrate; forming a pixel electrode on the thin film transistor; forming a sacrificial layer on the pixel electrode; forming a roof layer on the sacrificial layer; forming an upper insulating layer on the roof layer; forming a plurality of microcavities by removing the sacrificial layer; performing an ultraviolet (UV) surface treatment on the upper insulating layer; injecting a liquid crystal material into the plurality of microcavities; and cleaning a liquid crystal injecting portion formed between the upper insulating layer and the plurality of microcavities, wherein the upper insulating layer includes titanium oxide.

A surface of the upper insulating layer may be subjected to the UV surface treatment so as to become super hydrophilic.

The manufacturing method may further include, before the forming of the roof layer, forming a lower insulating layer on the sacrificial layer.

The manufacturing method may further include, before the forming of the lower insulating layer, forming a common electrode on the sacrificial layer.

The liquid crystal injecting portion may be formed along a direction in which a gate line connected to the thin film transistor is extended.

The forming of the sacrificial layer may include forming an open part along a portion overlapped with a data line connected to the thin film transistor.

According to an embodiment, the insulating layer which is in contact with the liquid crystal material is formed of titanium oxide and is subjected to an UV surface treatment, thereby allowing the insulating layer which is in contact with the liquid crystal material to be super hydrophilic. As a result, a cleaning effect for removing the remaining liquid crystal material may be improved.

### BRIEF DESCRIPTION OF THE DRAWINGS

FIG. 1 is a plan view showing a liquid crystal display according to an exemplary embodiment.

FIG. 2 is a cross-sectional view taken along a cutting plane line II-II of FIG. 1.

FIG. 3 is a cross-sectional view taken along a cutting plane line III-III of FIG. 1.

FIGS. 4, 5, 6, 7, 8, 9, 10, 11, 12, 13, 14, 15, and 16 are cross-sectional views showing a manufacturing method of a liquid crystal display according to an exemplary embodiment,

### DETAILED DESCRIPTION OF THE EMBODIMENTS

Exemplary embodiments will be described in detail with reference to the accompanying drawings. However, the inventive concept is not limited to the exemplary embodiments which are described herein, and may be modified in various different ways. Rather, the exemplary embodiments to be described below are provided so that the idea of the inventive concept can be sufficiently transferred to those skilled in the art to which the present application pertains.

In the drawings, thicknesses of layers and regions are exaggerated for clarity. In addition, in the case in which it is stated that a layer is present ‘on’ another layer or a substrate, the layer may be directly formed on another layer or the substrate or have other layer(s) interposed therebetween. Portions denoted by like reference numerals mean like elements throughout the specification.

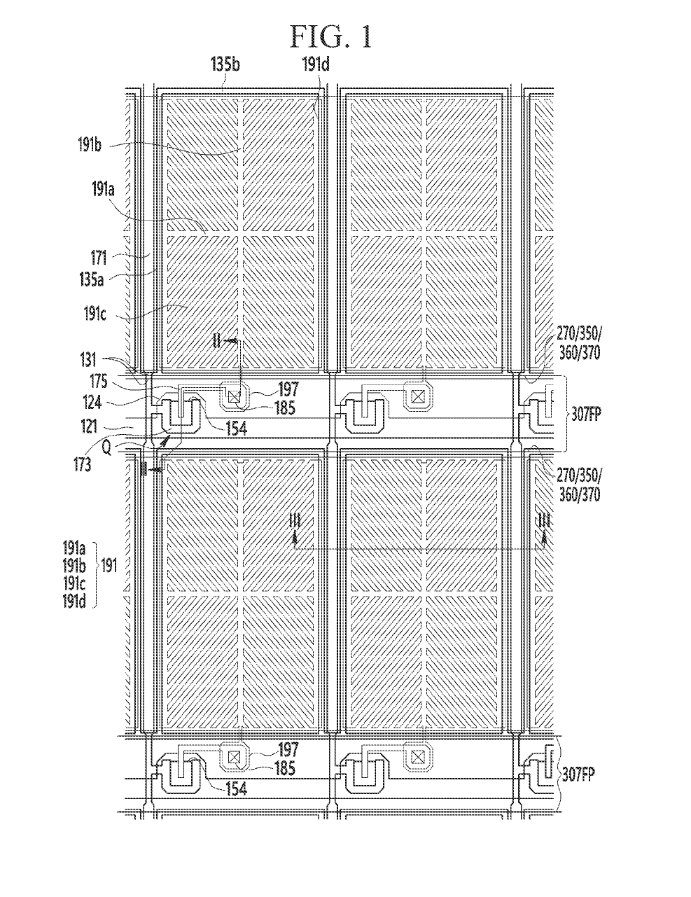

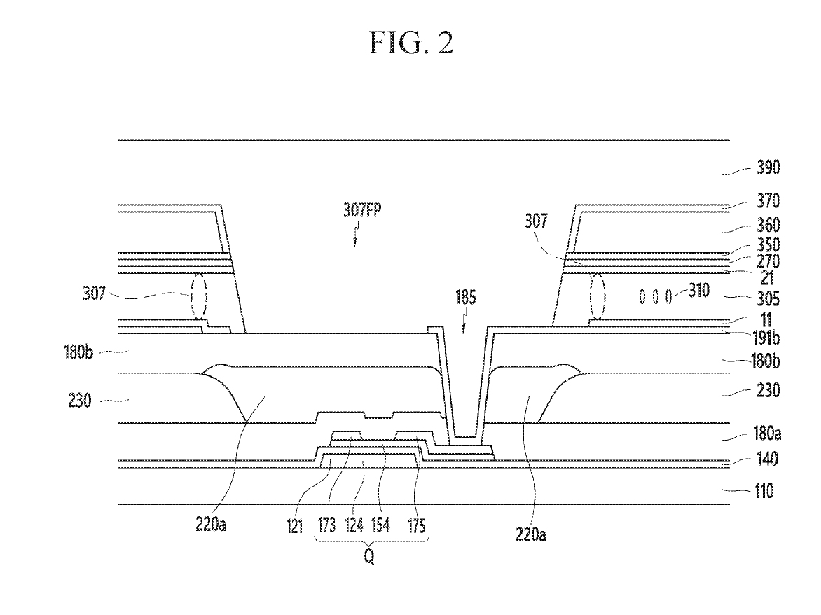

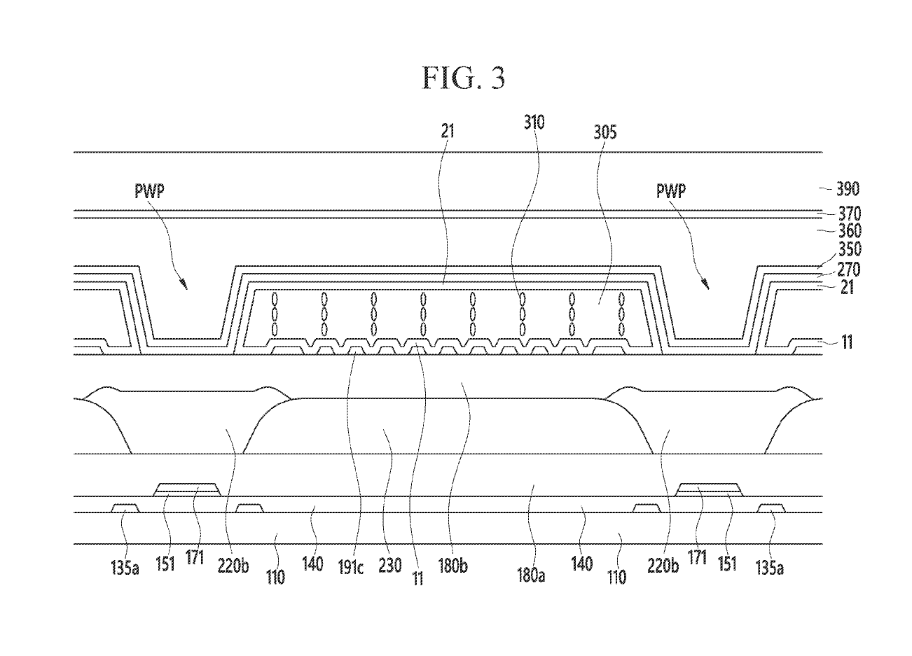

FIG. 1 is a plan view showing a liquid crystal display according to an exemplary embodiment. FIG. 2 is a cross-sectional view taken along a cutting plane line II-II of FIG. 1. FIG. 3 is a cross-sectional view taken along a cutting plane line III-III of FIG. 1. FIG. 1 shows a 2*2 pixel portion, which is a part among a plurality of pixels corresponding to a plurality of microcavities 305, respectively, and in the liquid crystal display according to an exemplary embodiment, the above-mentioned pixels may be repeatedly arranged in horizontal and vertical directions.

Referring to FIGS. 1 to 3, a gate line 121 and a sustain electrode line 131 are formed on a substrate 110 made of transparent glass, plastic, or the like. The gate line 121 includes a gate electrode 124. The sustain electrode line 131 is mainly extended in the horizontal direction and transfers a set voltage such as a common voltage Vcom. The sustain electrode line 131 includes a pair of vertical parts 135a that are extended to be substantially perpendicular to the gate line 121 and a horizontal part 135b that connects ends of the pair of vertical parts 135a to each other. The sustain electrodes 135a and 135b may have a structure surrounding a pixel electrode 191.

A gate insulating layer 140 is formed on the gate line 121 and the sustain electrode line 131. On the gate insulating layer 140, a semiconductor layer 151 disposed below the data line 171, and a semiconductor layer 154 disposed at a lower portion of source/drain electrodes 173/175 and a channel portion of a thin film transistor Q are formed.

A plurality of ohmic contacts may be formed on the respective semiconductor layers 151 and 154 and between a data line 171 and the source/drain electrodes 173/175, but are omitted in the drawings.

Data conductors 171, 173, and 175 including the source electrode 173, the data line 171 connected to the source electrode 173, and the drain electrode 175 are formed on the respective semiconductor layers 151 and 154 and the gate insulating layer 140.

The gate electrode 124, the source electrode 173, and the drain electrode 175 form the thin film transistor Q together with the semiconductor layer 154, and a channel of the thin film transistor Q is formed in the semiconductor layer 154 between the source electrode 173 and the drain electrode 175.

A first interlayer insulating layer 180a is formed on the data conductors 171, 173, and 175 and the exposed semiconductor layer 154. The first interlayer insulating layer 180a may include an inorganic insulating material or an organic insulating material such as silicon nitride (SiNx) or silicon oxide (SiOx).

A color filter 230 and light blocking members 220a and 220b are formed on the first interlayer insulating layer 180a.

First, the light blocking members 220a and 220b have a lattice structure having an opening part corresponding to a region displaying an image and are formed of a material through which light is not transmitted. The color filter 230 is formed in the opening part of the light blocking members 220a and 220b. The light blocking members 220a and 220b include a horizontal light blocking member 220a formed along a direction which is parallel to the gate line 121 and a vertical light blocking member 220b formed along a direction which is parallel to the data line 171.

The color filter 230 may display one of primary colors such as the three primary colors of red, green and blue. However, the color that the color filter 230 may display is not limited to the three primary colors such as red, green, and blue. For example, the color filter 230 may also display one of cyan, magenta, yellow, and white. The color filter 230 may be formed of a material displaying different colors for each of pixels which are adjacent to each other.

A second interlayer insulating layer 180b covering the color filter 230 and the light blocking members 220a and 220b is formed on the color filter 230 and the light blocking members 220a and 220b. The second interlayer insulating layer 180b may include an inorganic insulating material or an organic insulating material such as silicon nitride (SiNx) or silicon oxide (SiOx).

In the case in which a step occurs due to a thickness difference between the color fitter 230 and the light blocking members 220a and 220b, the step may be reduced or removed by allowing the second interlayer insulating layer 180b to include an organic insulating material.

Contact holes 185 that extend to and expose the drain electrode 175 may be formed in the color filter 230, the light blocking members 220a and 220b and the interlayer insulating layers 180a and 180b.

The pixel electrode 191 is disposed on the second interlayer insulating layer 180b. The pixel electrode 191 may be made of a transparent conductive material such as an ITO, an IZO, or the like.

The pixel electrode 191 has an overall shape of quadrangle and includes a cross stem part including a horizontal stem part 191a and a vertical stem part 191b intersecting with the horizontal stem part 191a. In addition, the pixel electrode 191 is partitioned into four sub-regions by the horizontal stem part 191b and the vertical stem part 191b and each of the sub-regions includes a plurality of fine branch parts 191c. Further, in the present exemplary embodiment, the pixel electrode 191 may further include outer stem parts 191d connecting the fine branch parts 191c at left and right outer portions of the pixel electrode 191. In the present exemplary embodiment, the outer stem parts 191d are disposed at the left and right outer portions of the pixel electrode 191, but may be disposed so as to be extended up to an upper portion or a lower portion of the pixel electrode 191.

The fine branch parts 191c of the pixel electrode 191 form an angle of approximately 40° to 45° with the gate line 121 or the horizontal stem part 191a. In addition, the fine branch parts 191c of the two neighboring sub-regions may be perpendicular to each other. In addition, the fine branch parts 191c may have a width which is gradually increased, or an interval between the fine branch parts 191c may be different.

The pixel electrode 191 includes an extension part 197 connected to a lower end of the vertical stem part 191b and having an area wider that of the vertical stem part 191b. The pixel electrode 191 is physically and electrically connected to the drain electrode 175 through the contact hole 185 by the extension part 197, and is applied with a data voltage from the drain electrode 175.

The description of the thin film transistor Q and the pixel electrode 191 described above is an example, and in order to improve side visibility, a structure of the thin film transistor and a design of the pixel electrode are not limited to the structure described in the present exemplary embodiment, but may be modified to reflect the contents according to an exemplary embodiment.

A lower alignment layer 11 is formed on the pixel electrode 191 and the lower alignment layer 11 may be a vertical alignment layer. The lower alignment layer 11, which is a liquid crystal alignment layer such as polyamic acid, polysiloxane, polyimide, or the like, and may be formed to include at least one of materials which are generally used.

An upper alignment layer 21 is positioned at a portion facing the lower alignment layer 11 and the microcavity 305 is formed between the lower alignment layer 11 and the upper alignment layer 21. The microcavity 305 is injected with a liquid crystal material 310 including a liquid crystal molecule, and the microcavity 305 have an inlet part 307. A plurality of microcavities 305 may be formed along a column direction of the pixel electrode 191, that is, the vertical direction. In the present exemplary embodiment, the alignment material forming the alignment layers 11 and 21 and the liquid crystal material 310 including the liquid crystal molecule may be injected into the microcavity 305 using capillary force. In the present exemplary embodiment, the lower alignment layer 11 and the upper alignment layer 21 are merely differentiated depending on a position thereof, and may be connected to each other as shown in FIG. 3. The lower alignment layer 11 and the upper alignment layer 21 may be simultaneously formed.

The microcavity 305 is partitioned in a vertical direction by a plurality of liquid crystal injecting portions 307FP positioned at portions overlapped with the gate line 121, so as to form the plurality of microcavities 305. The plurality of microcavities 305 may be formed along the column direction of the pixel electrode 191, that is, the vertical direction. In addition, the microcavity 305 is partitioned in a horizontal direction by a partition wall part PWP to be described below, an as to form the plurality of microcavities 305. The plurality of microcavities 305 may be formed along a row direction of the pixel electrode 191, that is, a horizontal direction to which the gate line 121 is extended. Each of the plurality of formed microcavities 305 may correspond to one or two or more pixel regions, and the pixel region may correspond to a region displaying a screen.

A common electrode 270 and a lower insulating layer 350 are disposed on the upper alignment layer 21. The common electrode 270 is applied with a common voltage and generates an electric field together with the pixel electrode 191 applied with the data voltage, so as to determine a direction in which the liquid crystal material 310 disposed in the microcavity 305 between the two electrodes is inclined. The common electrode 270 forms a capacitor together with the pixel electrode 191, so as to maintain the applied voltage even after the thin film transistor Q is turned off. The lower insulating layer 350 may be formed of silicon nitride (SiNx) or, silicon oxide (SiO₂).

The present exemplary embodiment describes the case in which the common electrode 270 is formed on an upper end portion of the microcavity 305, but in another exemplary embodiment, the common electrode 270 may be formed on a lower portion of the microcavity 305, thereby making it possible to drive the liquid crystal material 310 according to a horizontal electric field mode.

A roof layer 360 is disposed on the lower insulating layer 350. The roof layer serves to support the microcavity 305, which is a space between the pixel electrode 191 and the common electrode 270. The roof layer 360 may include photoresist or other organic materials.

An upper insulating layer 370 is disposed on the roof layer 360. The upper insulating layer 370 may be in contact with an upper surface of the roof layer 360. The upper insulating layer 370 according to the present exemplary embodiment may include titanium oxide TiO₂. A surface of the upper insulating layer 370 may be subjected to an ultraviolet treatment so as to be super hydrophilic. Water drops would not be generated due to the super hydrophilic property even if the upper insulating layer 370 including titanium oxide TiO₂ gets wet.

According to the present exemplary embodiment, the upper insulating layer 370 is in contact with the liquid crystal material 310 at the time of the injection of the liquid crystal material 310 and the remaining liquid crystal material 310 may remain on the surface of the upper insulating layer 370 after the liquid crystal material 310 is injected. After the liquid crystal material 310 is injected, a cleaning process may be performed by using water. In this case, water permeates between the upper insulating layer 370 being super hydrophilic and the remaining liquid crystal material 310, thereby making it possible to easily remove the remaining liquid crystal material 310. Therefore, a cleaning effect may be increased and a cleaning time may be reduced. Since the titanium oxide (TiO₂) material has property similar to silicon oxide (SiO₂), a layer may be formed by a chemical vapor deposition method.

As shown in FIG. 2, the upper insulating layer 370 may cover side portions of the roof layer 360. As a modified example, side walls of the lower insulating layer 350, the roof layer 360, and the upper insulating layer 370 may be formed so as to be substantially equally aligned with each other.

A capping layer 390 is disposed on the upper insulating layer 370. The capping layer 390 includes an organic material or an inorganic material. The capping layer 390 may be disposed in the liquid crystal injecting portion 307FP as well as on the upper insulating layer 370. In this case, the capping layer 390 may cover the inlet part 307 of the microcavity 305 exposed by the liquid crystal injecting portion 307FP. Although the present exemplary embodiment describes the case in which the liquid crystal material 310 is removed from the liquid crystal injecting portion 307FP the liquid crystal material 310 remaining after being injected into the microcavity 305 may remain in the liquid crystal injecting portion 307FP.

According to the present exemplary embodiment, as shown in FIG. 3, the partition wall part PWP is formed between the microcavities 305 that neighbor in the horizontal direction. The partition wall part PWP may be formed along a direction in which the data line 171 is extended and may be covered by the roof layer 360. The partition wall part PWP is filled with the common electrode 270, the lower insulating layer 350, the roof layer 360, and the upper insulating layer 370. The above-mentioned structure may form partition walls, thereby making it possible to partition or define the microcavity. According to the present exemplary embodiment, since the partition wall structure such as the partition wall part PWP is formed between the microcavities 305, even in the case in which the substrate 110 is bent, occurring stress may be small and a degree of modification of a cell gap may be reduced.

Although not shown, a polarizing plate may be formed on outer surface portions of the substrate 110 and the capping layer 390.

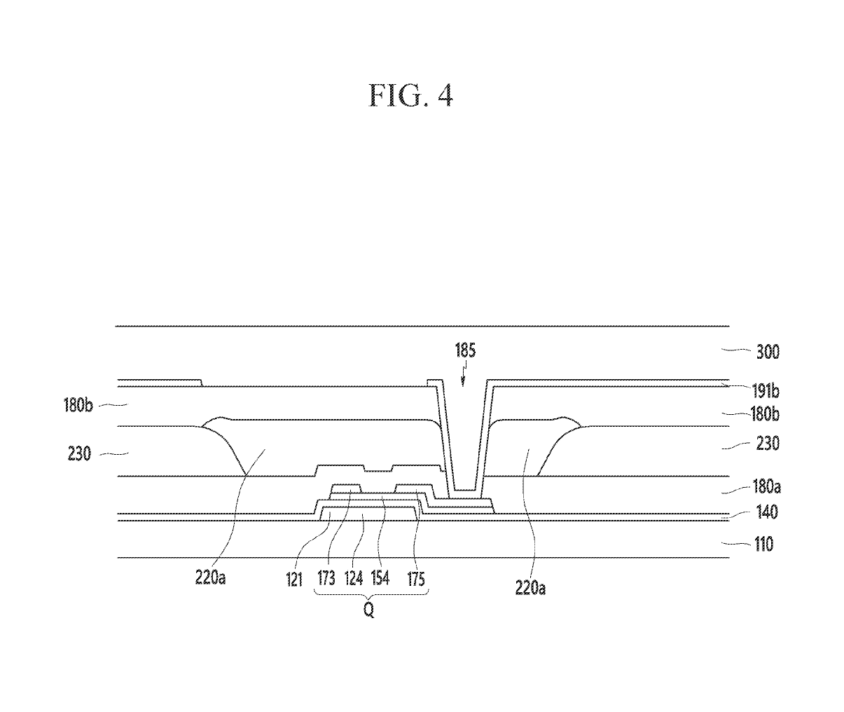

Hereinafter, an example of a manufacturing method of the liquid crystal display as described above will be described with reference to FIGS. 4 to 16. The example to be described below is one exemplary embodiment of the manufacturing method and may be modified in other forms.

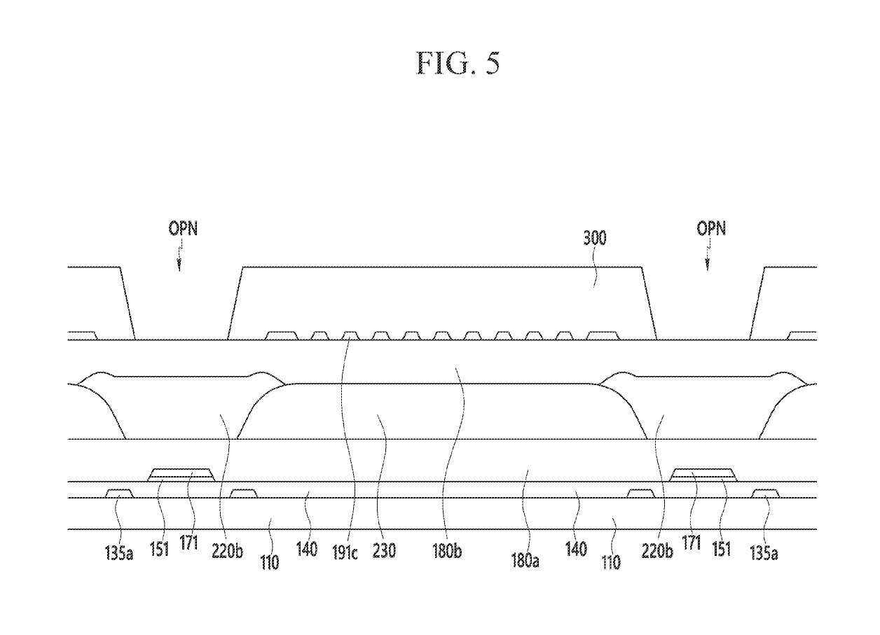

FIGS. 4 to 16 are cross-sectional views illustrating a method of manufacturing a liquid crystal display according to an exemplary embodiment. FIGS. 4, 6, 8, 10, 11, 13, and 15 are views sequentially showing a cross-sectional view taken along a cutting plane line III-III of FIG. 1 and FIGS. 5, 7, 9, 12, 14 and 16 are a cross-sectional view taken along a cutting plane line III-III of FIG. 1.

Referring to FIGS. 1, 4 and 5, in order to form a switching element which is generally known, on the substrate 110, the gate line 121 which is extended in the horizontal direction is formed, the gate insulating layer 140 is formed on the gate line 121, the semiconductor layers 151 and 154 are formed on the gate insulating layer 140, and the source electrode 173 and the drain electrode 175 are formed on the semiconductor layers 151 and 154. In this case, the data line 171 connected to the source electrode 173 may be formed so as to be extended in the vertical direction while intersecting with the gate tine 121.

The first interlayer insulating layer 180a is formed on the data conductors 171, 173, and 175 including the source electrode 173, the drain electrode 175, and the data line 171, and the exposed semiconductor layer 154.

The color filters 230 are formed at positions corresponding to the pixel regions on the first interlayer insulating layer 180a and the light blocking members 220a and 220b are formed between the color filters 230.

The second interlayer insulating layer 180b covering the color filter 230 and the light blocking members 220a and 220b are formed on the color filter 230 and the light blocking members 220a and 220b. The second interlayer insulating layer 180b is formed so as to have the contact hole 185 that electrically and physically connects the pixel electrode 191 and the drain electrode 175 to each other.

Next, the pixel electrode 191 is formed on the second interlayer insulating layer 180b and a sacrificial layer 300 is formed on the pixel electrode 191. As shown in FIG. 5, the sacrificial layer 300 has an open part OPN formed along the data line 171. In the subsequent process, the open part OPN is filled with the common electrode 270, the lower insulating layer 350, the roof layer 360, and the upper insulating layer 370, thereby making it possible to form the partition wall part PWP.

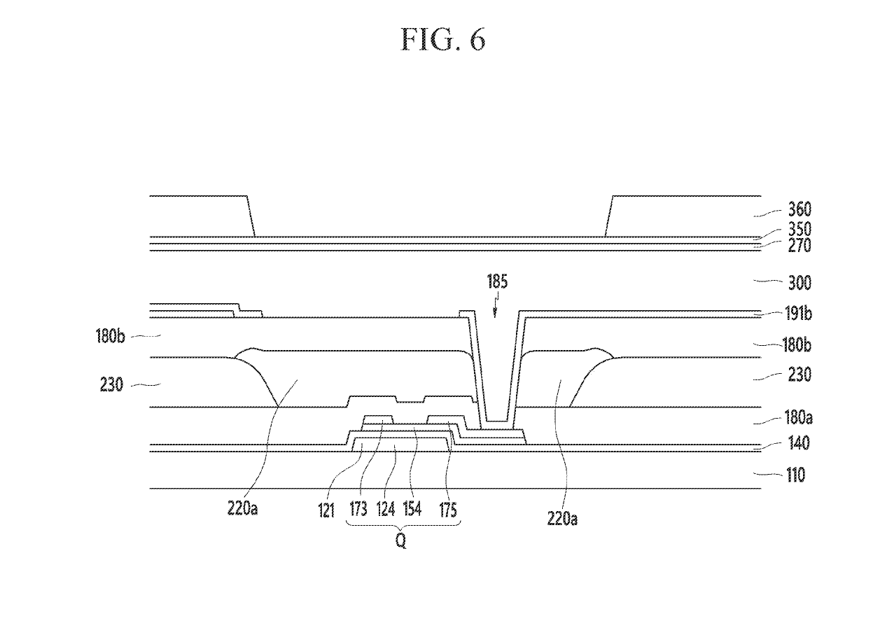

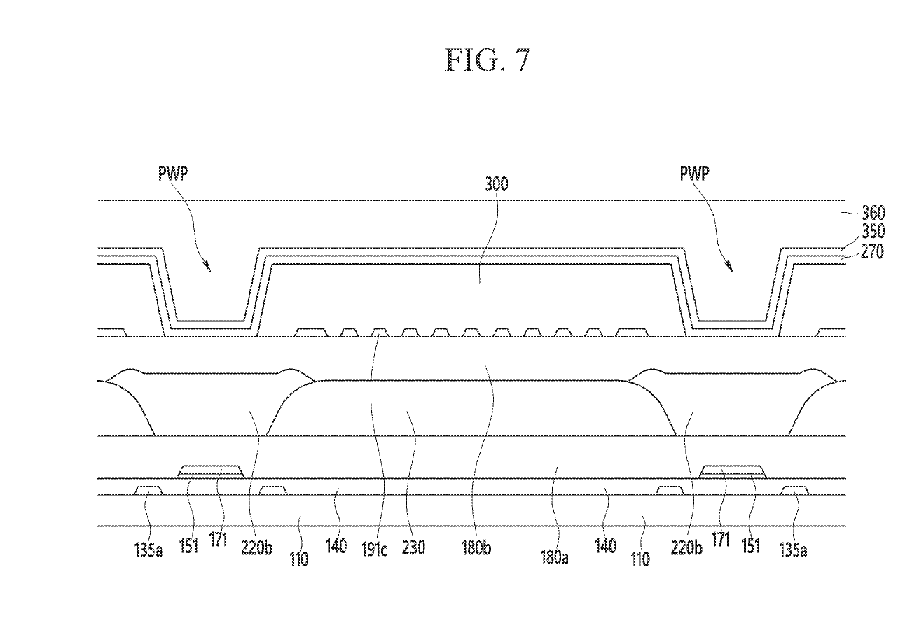

Referring to FIGS. 6 and 7, the common electrode 270, the lower insulating layer 350 and the roof layer 360 are sequentially formed on the sacrificial layer 300. The roof layer 360 may be removed from a region corresponding to the horizontal light: blocking member 220a disposed between the pixel regions that neighbor each other in the vertical direction by exposure and development processes. The roof layer 360 exposes the lower insulating layer 350 to the outside in the region corresponding to the horizontal light blocking member 220a. In this case, the common electrode 270, the lower insulating layer 350, and the roof layer 360 form the partition wall part PWP white filling the open part OPN formed on of the vertical light blocking member 220b, as shown in FIG. 7.

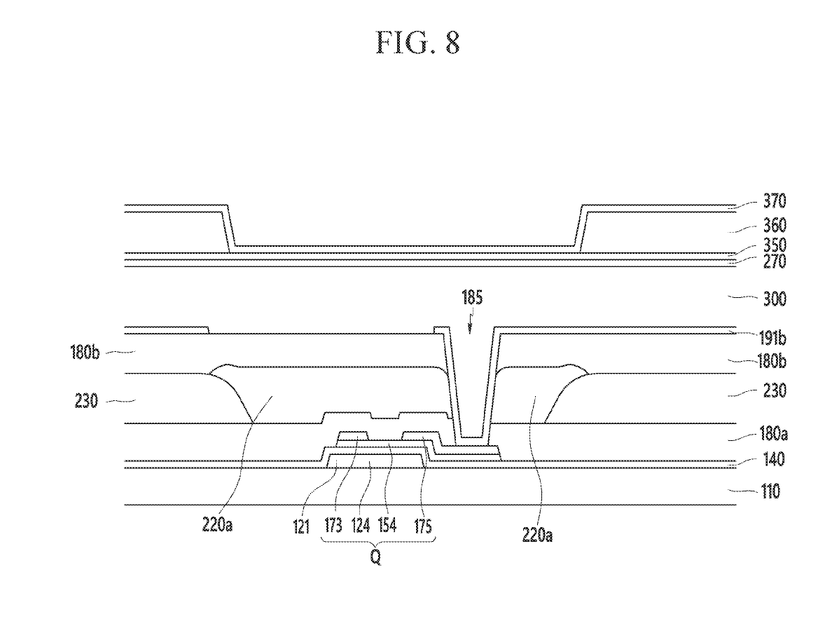

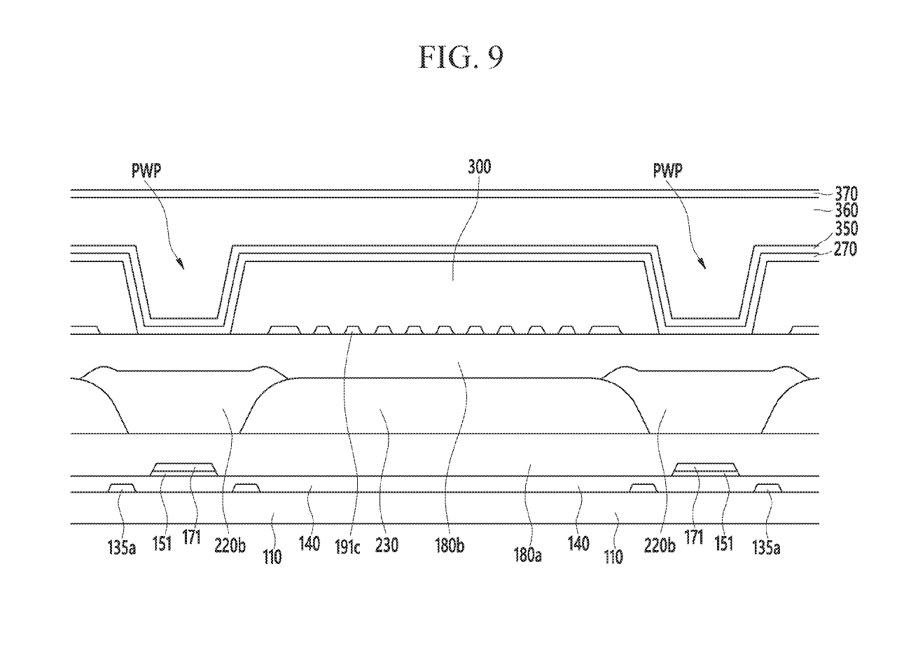

Referring to FIGS. 8 and 9, the upper insulating layer 370 is formed so as to cover the roof layer 360 and the exposed tower insulating layer 350. In this case, the upper insulating layer 370 may be formed of titanium oxide (TiO₂).

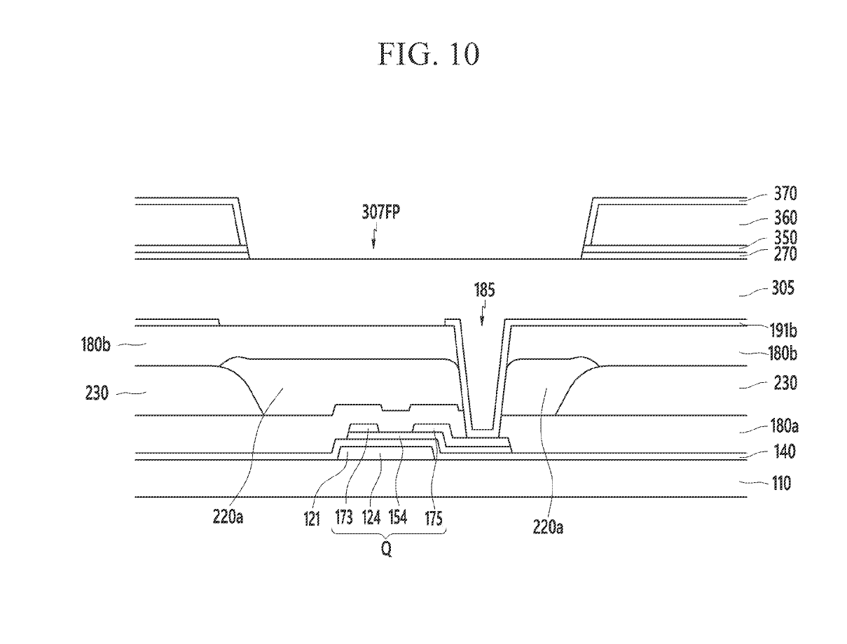

Referring to FIG. 10, the upper insulating layer 370, the lower insulating layer 350, and the common electrode 270 are etched to partially remove the upper insulating layer 370, the lower insulating layer 350, and the common electrode 270, thereby forming the liquid crystal injecting portion 307FP. In this case, the upper insulating layer 370 may have a structure in which it covers sides of the roof layer 360, but is not limited thereto. For example, the upper insulating layer 370 covering the sides of the roof layer 360 may be removed so as to expose the sides of the roof layer 360 to the outside.

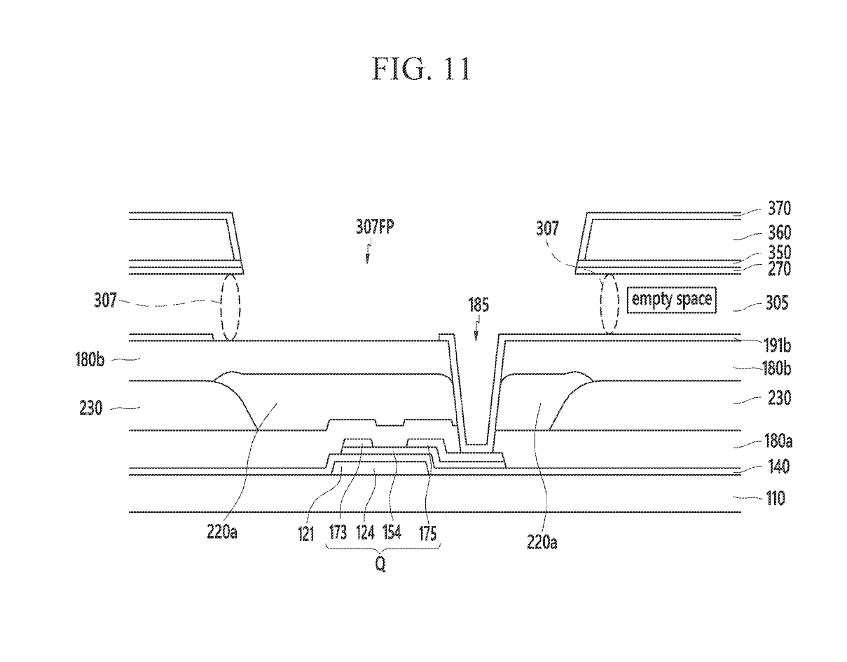

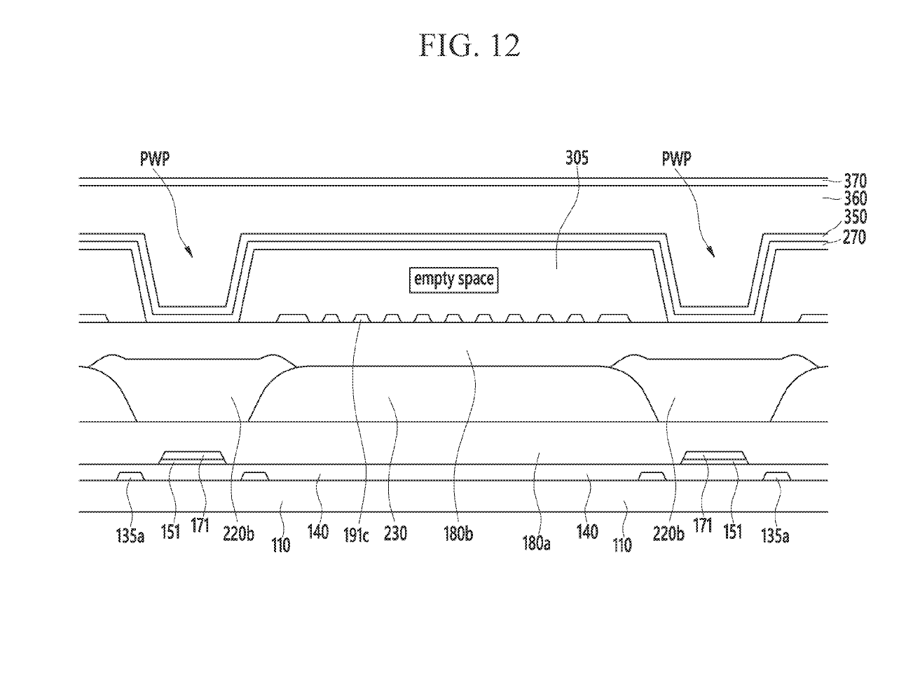

Referring to FIGS. 11 and 12, the sacrificial layer 300 is removed by an oxygen (O₂) asking process, a wet etching method, or the like through the liquid crystal injecting portion 307FP. In this case, the microcavity 305 having the inlet part 307 is formed. Since the sacrificial layer 300 is removed, the microcavity 305 is in an empty space state. The inlet part 307 may be formed along a direction which is in parallel to the gate line 121.

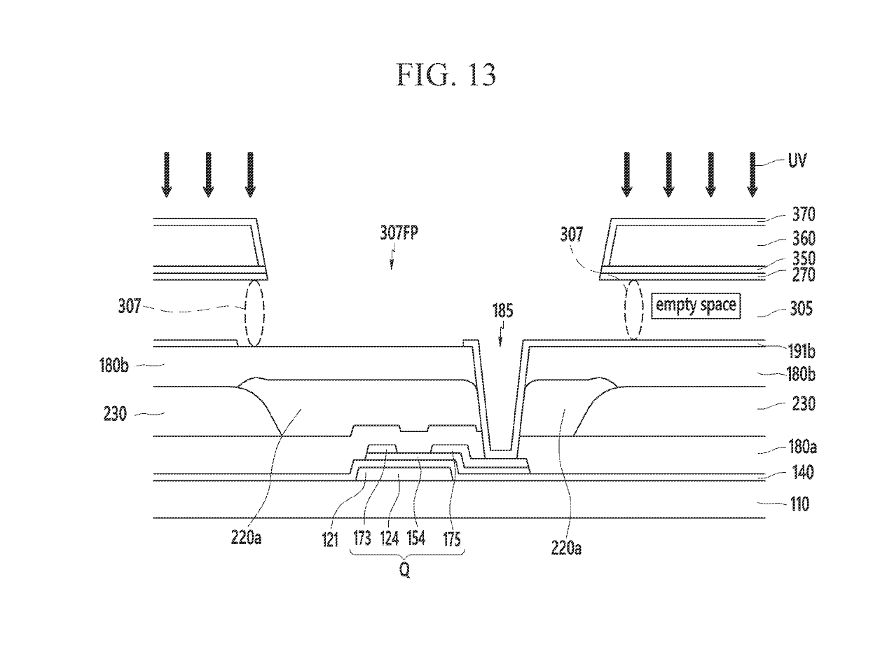

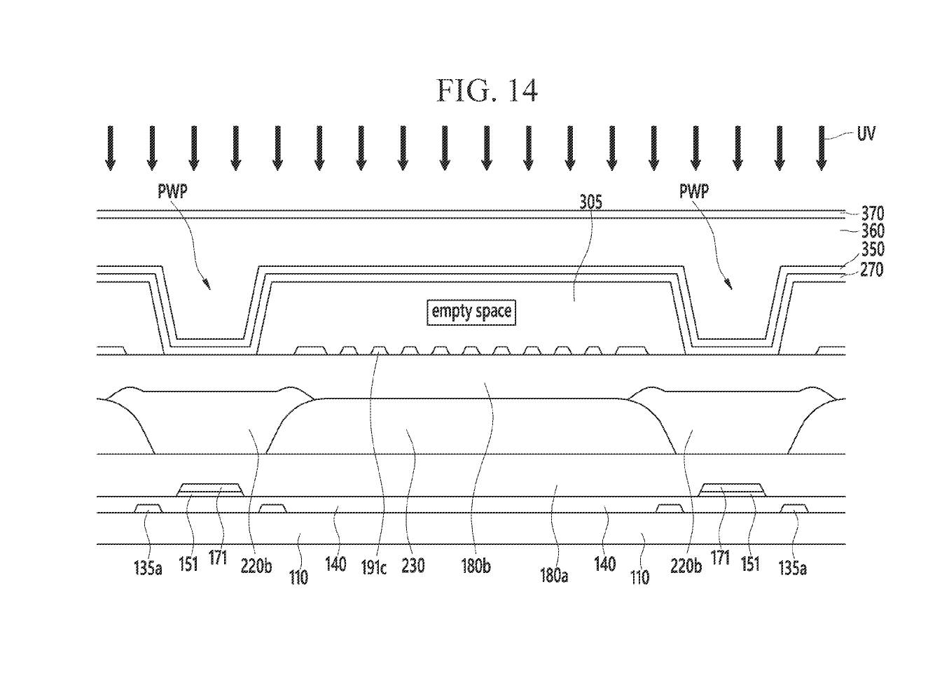

Referring to FIGS. 13 and 14, the upper insulating layer 370 is subjected to an ultraviolet (UV) surface treatment. In this case, a surface of the upper insulating layer 370 may be reformed so as to be super hydrophilic.

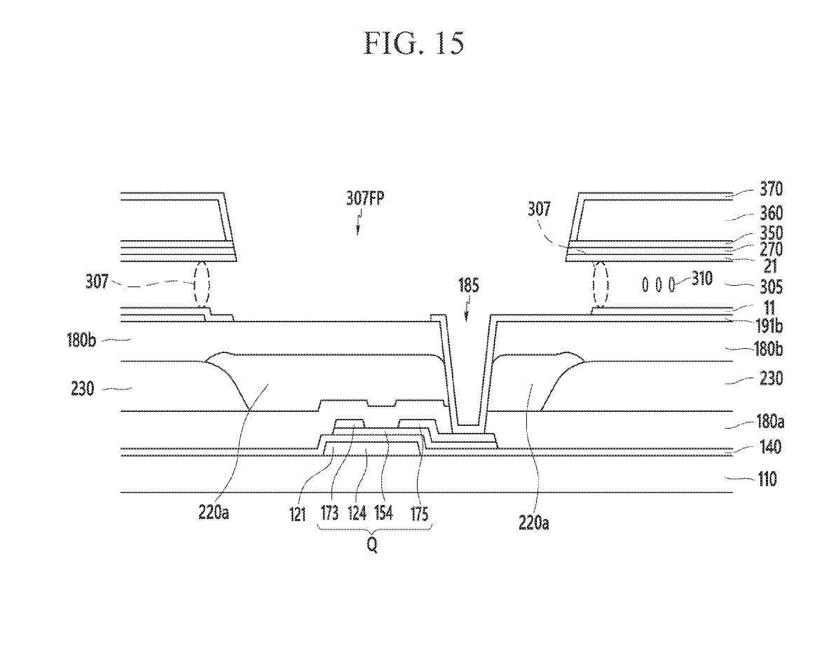

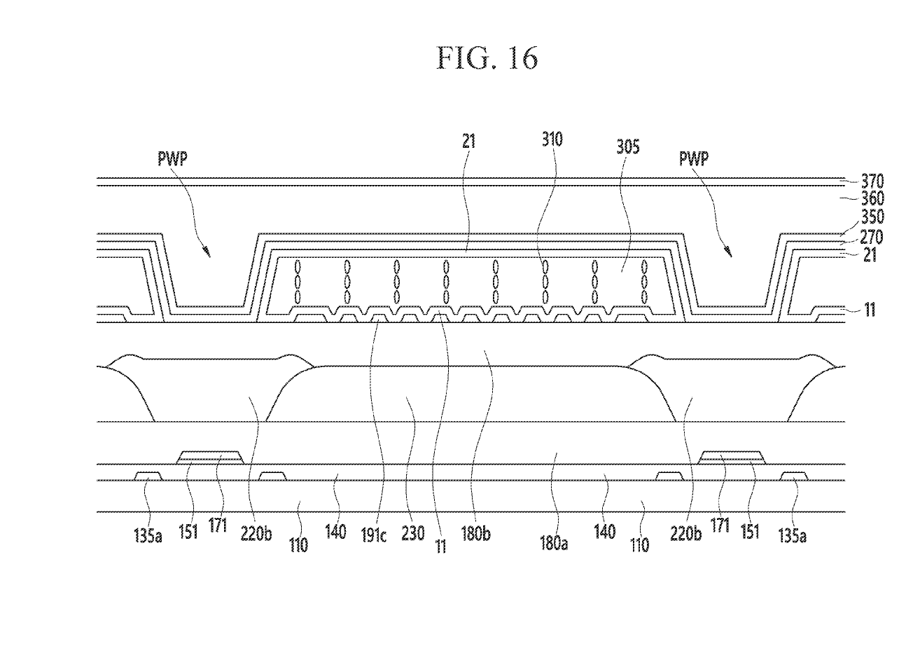

Referring to FIGS. 15 and 16, the alignment layers 11 and 21 are formed on the pixel electrode 191 and the common electrode 270 by injecting the alignment material through the inlet part 307. Specifically, after the alignment material including solids and solvent is injected through the inlet part 307, a bake process is performed.

Next, the liquid crystal material 310 may be injected into the liquid crystal injecting portion 307FP by using an ink jet method, or the like. In this case, the liquid crystal material 310 including the liquid crystal molecules may be injected into the microcavity 305 through the inlet part 307 by a capillary phenomenon, or the like.

Thereafter, a cleaning process may be performed by using water in order to remove the liquid crystal material remaining on the surface of the upper insulating layer 370. In this case, water permeates between the upper insulating layer 370 being super hydrophilic and the remaining liquid crystal material 310, thereby making it possible to easily remove the remaining liquid crystal material 310.

Originally, in order to remove the radical, or the like remaining on the surface of the layer, the cleaning process was performed in the past. Since the cleaning process for the UV surface treatment and the remaining liquid crystal removal is performed in the same method as the cleaning process for the removal of the radical, or the like according to the present exemplary embodiment, it may be performed without adding equipment or processes.

Next, in the case in which the capping layer 390 is formed on the upper insulating layer 370 so as to cover the inlet part 307 and the liquid crystal injecting portion 307FP, the liquid crystal display shown in FIGS. 1 to 3 may be formed.

### Description of Symbols

| | | | |
|---|---|---|---|
| 300 | sacrificial layer | 305 | microcavity |
| 307 | inlet part | 307FP | liquid crystal injecting portion |
| 350 | lower insulating layer | 360 | roof layer |
| 370 | upper insulating layer | 390 | capping layer |

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a substrate;
a thin film transistor disposed on the substrate;
a pixel electrode disposed on the thin film transistor;
a roof layer facing the pixel electrode;
an upper insulating layer disposed on the roof layer; and
a liquid crystal layer disposed between the pixel electrode and the roof layer and comprising a plurality of microcavities including liquid crystal molecules,
wherein the upper insulating layer comprises titanium oxide.

2. The liquid crystal display of claim 1, wherein:
the upper insulating layer comprises a surface reformed by an ultraviolet (UV) surface treatment.

3. The liquid crystal display of claim 2, wherein:
the surface of the upper insulating layer which is reformed by the ultraviolet (UV) surface treatment is super hydrophilic.

4. The liquid crystal display of claim 3, further comprising:
a lower insulating layer disposed below the roof layer and facing the pixel electrode based on the microcavity.

5. The liquid crystal display of claim 4, wherein:
the lower insulating layer comprises silicon nitride or silicon oxide.

6. The liquid crystal display of claim 5 further comprising:
a common electrode disposed below the lower insulating layer and facing the pixel electrode based on the microcavity.

7. The liquid crystal display of claim 1, wherein:
the roof layer covers an open part formed between the plurality of microcavities adjacent to each other.

8. The liquid crystal display of claim 7, further comprising:
a capping layer disposed on the upper insulating layer.

9. The liquid crystal display of claim 8, wherein:
the plurality of microcavities have a liquid crystal injecting portion formed therebetween and the capping layer covers the liquid crystal injecting portion.

10. A manufacturing method of a liquid crystal display, the manufacturing method comprising:
forming a thin film transistor on a substrate;
forming a pixel electrode on the thin film transistor;
forming a sacrificial layer on the pixel electrode;
forming a roof layer on the sacrificial layer;
forming an upper insulating layer an the roof layer;
forming a plurality of microcavities by removing the sacrificial layer:
performing an ultraviolet (UV) surface treatment on the upper insulating layer;
injecting a liquid crystal material into the plurality of microcavities; and
cleaning a liquid crystal injecting portion formed between the upper insulating layer and the plurality of microcavities,
wherein the upper insulating layer includes titanium oxide.

11. The manufacturing method of claim 10, wherein:
a surface of the upper insulating layer is subjected to the UV surface treatment so as to become super hydrophilic.

12. The manufacturing method of claim 11, further comprising:
before the forming of the roof layer, forming a lower insulating layer on the sacrificial layer.

13. The manufacturing method of claim 12, further comprising:
before the forming of the lower insulating layer, forming a common electrode on the sacrificial layer.

14. The manufacturing method of claim 13, wherein:
the liquid crystal injecting portion is formed along a direction in which a gate line connected to the thin film transistor is extended.

15. The manufacturing method of claim 14, wherein:
the forming of the sacrificial layer includes forming an open part along a portion overlapped with a data line connected to the thin film transistor.
